(19) United States
(12) Patent Application Publication
(10) Pub. No.: US 2002/0121152 A1
(43) Pub. Date: Sep. 5, 2002

(54) Phased gear set comprised of a pair of phased gears

(76) Inventors: David C. White, Dryden, NY (US); Philip J. Mott, Dryden, NY (US)

Correspondence Address: Attn: Patent Docket Administrator, BorgWarner, Inc., 3001 W. Big Beaver Rd. Suite 200, P.O. Box 5060, Troy, MI, 48007-5060, US

(21) Appl. No.: 10/090,509

(22) Filed: Mar. 4, 2002

Related U.S. Application Data
(60) Provisional application No. 60/273,363, filed on Mar. 5, 2001.

(51) Int. Cl. F16H 55/18

(52) U.S. Cl. 74/445; 74/409

(57) ABSTRACT

A gear set comprising a pair of phased split gears, a driven gear (1) and a driving gear (2). The sections ((3)(4) and (5)(6)) of each of the split gears are offset from each other, preferably by one-half pitch, and in one of the two split gears, the sections of the gear may rotate relative to each other. The two sections of that gear must then be connected by a means that allows the transmission of torque between the two, preferably by being resiliently loaded by a torsion spring (33) or other bias medium to the leading edge of the meshing tooth of the mating gear. When the driving split gear is turned, force is initially applied to the driven gear through the resilient bias medium. This allows perfect mesh between the two gears in the drive while taking manufacturing variability into consideration.

### FIELD OF THE INVENTION

The invention pertains to the field of power transmission mechanisms. More particularly, the invention pertains to gears and gear sets.

### BACKGROUND OF THE INVENTION

Split gears, that is, gears having two sets of sub-gears on a single shaft, in which the teeth of the sub-gears are offset from one another, are known to the art. For example, see Ward, U.S. Pat. No. 108,539, “Mill Gearing”.

These gears are often called “anti-backlash gears”, and in most cases one of the sub-gears is biased by a spring or torsion bar or the like, as in Gaither, U.S. Pat. No. 2,868,033, “Torsion Bar Anti-Backlash Gear”, in order to take up the slack or “backlash” between the teeth of the split gear and the conventional gear with which it mates. One common type of anti-backlash gear is the “scissor gear”, in which the spring-loaded subgear is a relatively small part of the thickness of the gear, as in Shook, et. al, U.S. Pat. No. 5,979,259, “Gear Train Assembly Including a Scissor Gear”. In such gear sets, the split gears mesh with conventional gears, and the fixed sub-gear (the one which is rigidly attached to the shaft) is the primary power transmission component. The spring-loaded sub-gear is biased forward against the trailing edge of the meshing teeth, to provide a constant wedging action and take up the backlash between the two sets of gears.

Yasukawa and Fujita, U.S. Pat. No. 4,688,441, “Gear Assembly for Mating with Third Gear without Backlash”, shows a split gear for use in an antibacklash gear mechanism, in which the halves of the split gear are biased through use of a “C-clip”, and shows a method of assembling the gear. When assembled, the gear is biased as in the other anti-backlash gear assemblies, to provide constant force against the trailing edge of the mating conventional gear teeth.

There have long been gear assemblies that use two sets of split gears, meshing with each other. This arrangement is described in Henry T. Brown's 1868 book, “507 Mechanical Movements” (reprinted 1984 by Lindsay Publications, Bradley Ill. ), on pages 16-17, as “a kind of gearing used to transmit great force and give a continuous bearing to the teeth. Each wheel is composed of two, three or more distinct spur gears. The teeth, instead of being in line, are arranged in steps . . . This system is sometimes used for driving screw propellers . . .”

Producing a gear set of this type as rigid assemblies could prove to be difficult. If the gear set is considered as two separate gear sets driving the same set of shafts (each offset from the other) it can be seen that each set must come into contact with one another at exactly the same time if they are to equally share the load. Additionally, gears typically have backlash (or spacing between the gear teeth of meshing gears). If this backlash is not the same between the two sets of teeth, they again will not be able to equally share the load.

In this type of mechanism, either one of the gears is set in an anti-backlash arrangement as described above, or the two sets of sub-gears are all fixed to the shafts, as shown in the Manna, Viktora and Ueno et al patents described below.

Manna, U.S. Pat. No. 4,106,360, “Indexed and Coworking Gears”, an inner double gear meshes with an outer double gear in the form of a ring with teeth projecting inward. The outer gear assembly is initially loose, and the teeth are moved relatively until they mesh with the teeth of the inner drive gear, then they are fixed in place.

Viktora, U.S. Pat. No. 5,092,751, “Split Gear Pump Mechanism with Gear Offset”, is a gear-type oil pump, in which the gears which make up the impellers in the pump are split gears, with the halves of the gears offset slightly and fixed to the shafts. Viktora shows (FIGS. 8 and 9) a configuration with half-pitch offset gears, but says that this would not work in a pump and that an offset of no more than a quarter-pitch is preferred. The purpose of the offset is to minimize pulsations in the oil output.

Ueno and Bushimata, U.S. Pat. No. 5,181,433, “Gear”, shows a gear set with two split gears, the halves of the split gears being offset by one-half pitch and fixed to the shafts. According to the patent, the halves of the gears mesh without backlash, which the patent says minimizes noise and vibration.

The BorgWarner “Gemini” gear and chain system, embodied in Ledvina and Mott, U.S. Pat. No. 5,427,580, “Phased Chain Assemblies”, among others, uses two chains which run on split sprockets which are offset by half a link. The Gemini arrangement minimizes noise and vibration caused by the chain-sprocket impact sounds.

### SUMMARY OF THE INVENTION

The invention is a gear set comprising a pair of phased split gears.

The sections of each of the split gears are offset from each other, preferably by one-half pitch, and in one of the two split gears, the sections of the gear may rotate relative to each other. The two sections of that gear must then be connected by a means that allows the transmission of torque between the two, preferably by being resiliently loaded by a torsion spring or other bias medium to the leading edge of the meshing tooth of the mating gear.

When the driving split gear is turned, force is initially applied to the driven gear through the resilient bias medium. This allows perfect mesh between the two gears in the drive while taking manufacturing variability into consideration.

### BRIEF DESCRIPTION OF THE DRAWING

FIG. 1 shows a perspective view of a phased gear set according to the teachings of the invention.

FIG. 2 shows a detail of the meshed teeth of a phased gear set according to the teachings of the invention.

FIG. 3 shows an exploded view of a phased gear with a torsion spring resilient element which can be used with the invention.

FIG. 4 shows a view of an embodiment of the invention with the driving gear smaller than the driven gear, with the driven gear cut away to show the torsion spring and recess.

FIG. 5 shows an alternate embodiment of the gear of the invention, having opposing helical teeth (herringbone).

FIG. 6 shows an alternate embodiment of the gear of the invention, having helical teeth

### DESCRIPTION OF THE PREFERRED EMBODIMENT

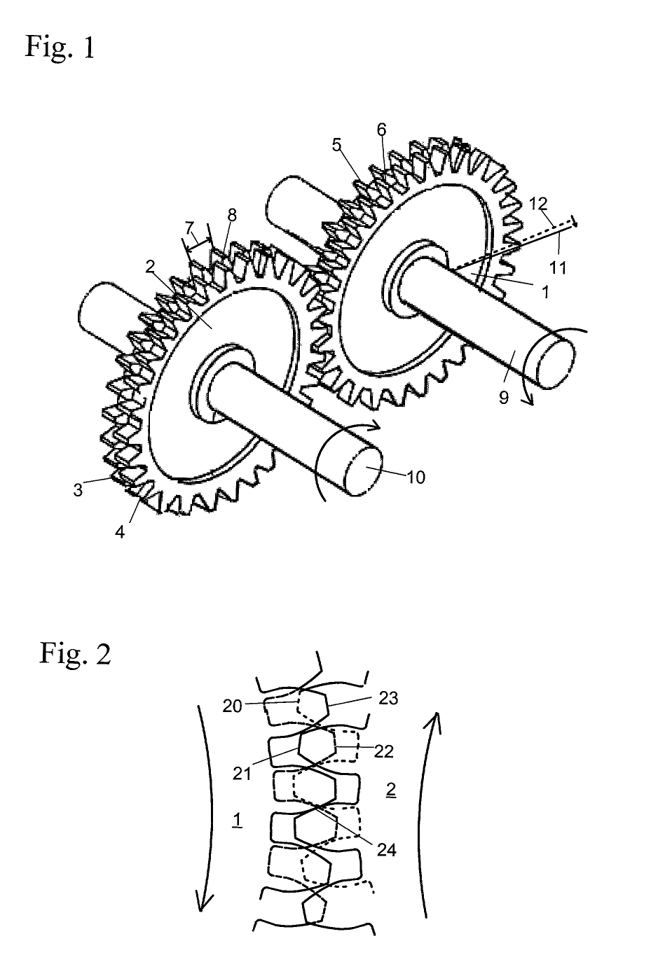

The invention is a “Gemini” gear set, as shown in FIGS. 1 and 4. In this gear set, each gear is figuratively split in two at the center of its tooth face. The halves of each gear are then rotated typically by one-half pitch, or an angle of 0.5×(360/N) where N is the number of teeth on the gear. This amount of rotation would line up the tip of the tooth on one side of the gear with the toe or tooth space of a tooth on the adjacent side. It should be noted that the amount of offset between the gear halves is not limited to this equation, but NVH reduction should be maximized at this amount of rotation. The two (or more) gears in the gear set can then be mated as indicated in FIGS. 1 and 4.

FIG. 1 shows a phased gear set of the invention. The gear set has two gears (1) and (2) mounted on shafts (9) and (10), respectively. For the purposes of explanation, gear (1) will be referred to in this description as the “driven gear” and gear (2) as the “driving gear”, although it will be understood that either gear could actually be driving or driven.

Each of the two gears is split into two sections or sub-gears—driven gear (1) is divided into sections (5) and (6), driving gear (2) is divided into sections (3) and (4). The teeth (8) of each section of each gear are formed with the same intertooth spacing or “pitch” (7).

Both sections of the driving gear (1) are fixed to shaft (10), with the teeth of section (3) being one-half pitch offset from the teeth of section (4), so that the teeth of section (3) are positioned next to the tooth spaces of section (4).

In driven gear (2), sections (5) and (6) are also offset from each other by approximately one-half pitch. However, only one of the two sections (5) is fixed to shaft (9). Section (6) is capable of turning on shaft (9) by a small amount, from a first position (12) to a second position (11), the second position (11) being slightly offset toward the direction of rotation from the first position (12). The moving section (6) is biased toward the second position by a spring, c-clip, torsion bar, or other resilient element, which acts against the fixed section (5).

FIG. 2 shows a detail of the meshing teeth of gears (1) and (2). In this figure (20) are the teeth of the fixed portion (5) of driven gear (1) and (21) are the teeth of moving portion (6). The teeth of driving gear (2) are (22) and (23).

Thus, unlike anti-backlash gears, where the spring biases the moving section in the other direction to wedge the teeth together with a constant force, in the present invention the resilient element presses (24) the teeth (21) of the moving section (6) of driven gear (1) against the leading edge of the meshing teeth (23) of driving gear (2). As the driving gear (2) begins to apply force in the direction indicated by the arrows, the force is initially acting upon the resilient element, and the resilient element passes the force on to the fixed section (5), and thus on to the driven shaft (9). As the force increases, moving section (6) moves against the resistance of the resilient element toward the second position (11). When the moving section (6) reaches the second position (11), the gears are fully engaged, and the teeth of the other sections (3) and (5) are engaged as well, so that driving gear (2) is directly driving driven gear (1) using both sections of each gear. If desired, a stop may be provided in the driven gear (2), so that the moving section cannot move past the second position (11).

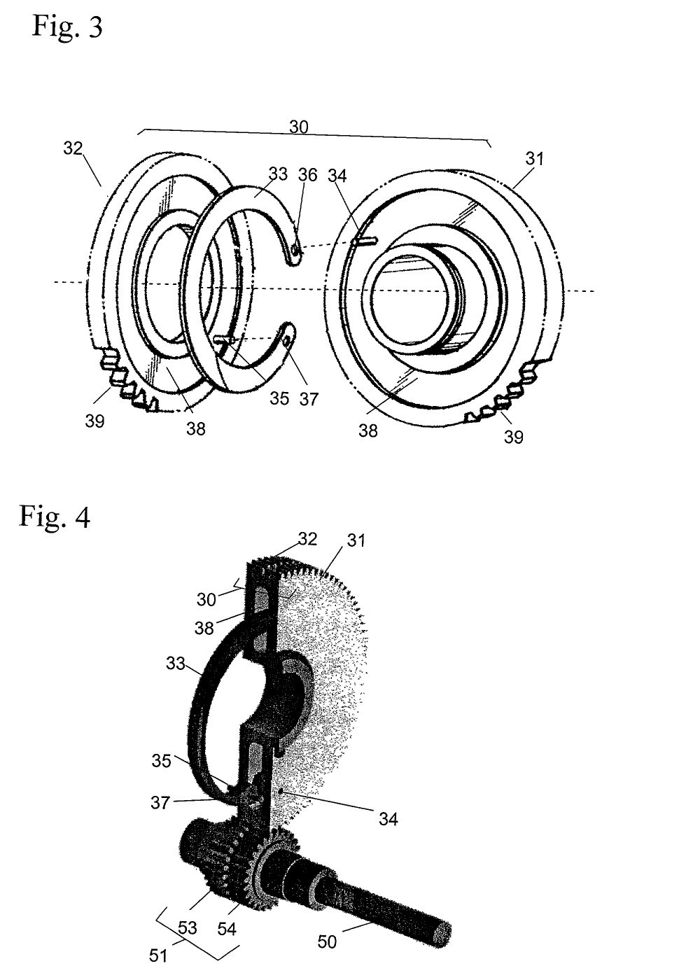

In the example in FIGS. 3 and 4, the two halves (31) and (32) of the driven gear (30) are connected by torsion spring (33). The torsion spring (33) could be a C-clip, as shown in the figures, or could have another design as known to the art. The device is not limited to this type of connection. Other means such as compression springs could also be used.

One end of the torsion spring (33) is rigidly affixed to one half (32) of the gear (30) with, for example, a pin (35) fitting through a hole (37) in the spring (33), while the other end of the spring (33) is affixed to the other half (31) with a similar pin (34) and hole (36). In this configuration, an internal pocket (38) is formed between the gear halves to house the torsion spring (33).

FIG. 4 shows how the driven gear (30) sections (31) and (32) mate with driving gear (51) sections (54) and (53), respectively, so that force applied to driving shaft (50) will apply force through the torsion spring (33) to the fixed section (31) of driven gear (30) and thus to the driven shaft (omitted in FIG. 4 for illustration purposes).

FIG. 1 shows an embodiment of the invention with the two gears (1) and (2) of equal size. In FIG. 4, the split driven gear (30) is larger than driving gear (51), but there is no limitation to which gear is split, or which is driven and which is driving. Typically the choice will be made due to packaging restraints.

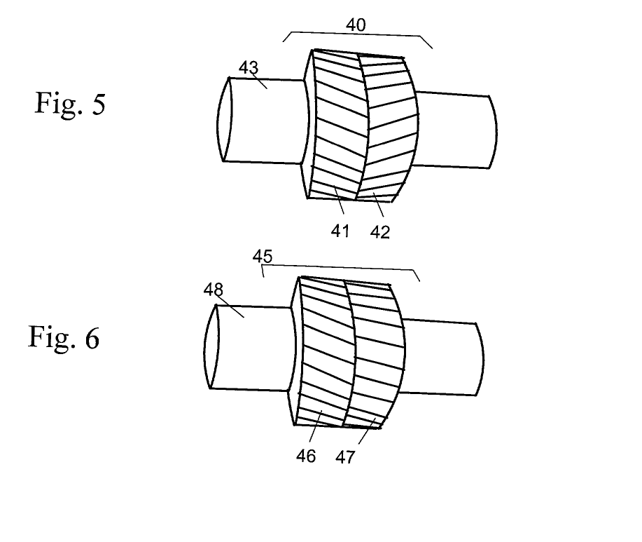

In FIGS. 1 through 4, the gears are shown as spur or square-cut gears. FIGS. 5 and 6 show that the same split-gear arrangement may be manufactured for helical gears. In FIG. 5, the slant of the helical gear sections (41) and (42) of gear (40) on shaft (43) is opposed, forming a phased herringbone type gear. In FIG. 6, the slant of the gear sections (46) and (47) of gear (45) on shaft (48) are parallel, forming a phased helical gear. In either embodiment, as in the spur gear embodiment of FIGS. 1-4, the mating split gear to gears (40) or (45) would be of the same design as the gear (40) or (45), and either gear (40) or (45) or the mating gear can have the resilient bias element biasing one movable section.

Accordingly, it is to be understood that the embodiments of the invention herein described are merely illustrative of the application of the principles of the invention. Reference herein to details of the illustrated embodiments are not intended to limit the scope of the claims, which themselves recite those features regarded as essential to the invention. what is claimed is

1. A gear set comprising:
a) a first phased gear (2) having a thickness, and a plurality of teeth spaced at a pitch around a circumference of the gear, the thickness of the first gear being split into a first section (3) and a second section (4), the teeth of the first section being offset from the teeth of the second section by one-half pitch;
b) a second phased gear (1) having a thickness, and a plurality of teeth spaced at a pitch around a circumference of the gear, the thickness of the second gear being split into a first section (5) and a second section (6) rotatable on an axis of rotation between a first position to a second position, the second position being rotationally opposite a direction of rotation of the gear from the first position and the first position representing a position where the teeth of the first section are offset from the teeth of the second section by approximately one-half pitch;
c) a resilient element (33) biasing the second section of the second phased gear toward the second position, such that when the teeth of the first phased gear are meshed with the teeth of the second phased gear, and a rotational force is applied to the one of the phased gears in the direction of rotation, the force is applied to the other gear through the resilient element.

2. The gear set of claim 1, in which the resilient element is a torsion spring located in a recess formed between the first section of the second phased gear and the second section of the second phased gear.

3. The gear set of claim 1, in which the second phased gear further comprises a stop for preventing rotational movement of the second section of the second gear further in the direction of rotation than the first position, such that when the gear set is driven in the direction of rotation force is applied through the resilient element only until the second section rotates to the first position, after which the stop is reached and force is applied directly to the shaft.

4. The gear set of claim 1, in which the teeth of the first gear and second gear are square cut.

5. The gear set of claim 1, in which the teeth of the first gear and second gear are helically cut.

6. The gear set of claim 5, in which the teeth of the first section of each gear and the teeth of the second section of each gear are opposite, so that the teeth form a herringbone pattern.
